(19) United States
(12) Patent Application Publication
(10) Pub. No.: US 2018/0104992 A1
(43) Pub. Date: Apr. 19, 2018

(54) Tire Comprising A Tread Layer Containing Channels

(71) Applicant: COMPAGNIE GENERALE DES ETABLISSEMENTS MICHELIN, Clermont-Ferrand (FR)

(72) Inventors: Marie-Hélène VANTAL, Clemont-Ferrand Cedex 9 (FR); Héloïse DEBORDEAUX, Clemont-Ferrand Cedex 9 (FR); Mathieu VANDAELE, Clemont-Ferrand Cedex 9 (FR); Kazutaka YOKOKAWA, Clemont-Ferrand Cedex 9 (FR); Vincent LEDIEU, Clemont-Ferrand Cedex 9 (FR); Quentin BONNETON, Ladoux Clemont-Ferrand Cedex 9 (FR)

(21) Appl. No.: 15/560,673

(22) PCT Filed: Mar. 24, 2016
(86) PCT No.: PCT/FR2016/050657

§ 371 Date: Sep. 22, 2017

(30) Foreign Application Priority Data
Apr. 1, 2015 (FR) 1552806

(51) Int. Cl. B60C 11/12; B60C 11/01

(52) U.S. Cl. CPC B60C 11/1281; B60C 11/01

(57) ABSTRACT

Tire comprising a tread (3), with a tread surface contacting the road surface, a shoulder region (5) partially delimiting the tread (3), and a plurality of complex cutouts (6) extending through the tread (3) and through the shoulder region (5). Each complex cutout (6) comprises a sipe (7) that leads onto the tread surface and a channel (8) that extends the sipe (7) into the depth of the tread and leads onto a surface (9) of the shoulder region (5). Channel (8) of sipe (7) has a main part (11) extending through tread (3) and a widened part (12) extending through shoulder region (5) from the main part of the channel to surface (9) of shoulder region (5). As seen in cross section, the widened part (12) makes, with the surface (9) of the shoulder region (5), an outlet angle δ of less than 90 degrees.

### FIELD OF THE INVENTION

The present invention relates to a tire comprising a tread. More particularly, the invention relates to a tread comprising a plurality of channels which are not visible when the tread is in a new state.

### PRIOR ART

FIG. 1 schematically depicts a part of a tire 1 according to the prior art. The tire comprises a tread 3 having a tread surface intended to come into contact with a road surface when the tire is being driven on. The tire also comprises shoulder regions 5 delimiting the tread. Said tire also comprises a plurality of complex cutouts 6 that extend through the tread 3 and through the shoulder regions 5. Each complex cutout 6 comprises a sipe 7 that leads onto the tread surface and a channel 8 that extends the sipe 7 into the depth of the tread. The channel 8 leads onto a surface 9 of the shoulder region 5, forming a generally circular line. The channel 8 thus helps to improve the evacuation of water from the tread when the tire is rolling on a wet road surface.

FIG. 2 depicts a cross-sectional view in the region of the channel 8 emerging onto the surface 9 of the shoulder region 5. In said FIG. 2, it can be seen that the channel 8 leads out perpendicularly at the surface 9 of the shoulder region 5. In other words, the outlet angle δ, measured between the channel 8 and the surface 9 of the shoulder region 5, is equal to 90 degrees. The outlet 10 between the channel and the surface 9 is particularly sensitive to transverse forces to which the shoulder region can be subjected, notably on cornering and particularly at the limits of grip. Under the effect of mechanical stresses, for example through the action of stones, some of the rubber present in this outlet region 10 can tear. These tears are likely to cause incipient cracks that can propagate through the rest of the tire.

Therefore, there is a need to improve the evacuation of water from the tread when the tire is rolling on a wet road surface, while limiting the risks of cracks being created in the shoulder region of the tire.

### Definitions

A “tire” means all types of resilient tread, whether or not it is subjected to an internal pressure.

A “rubber material” means a diene elastomer, that is to say, in a known way, an elastomer which is based, at least partially (i.e. is a homopolymer or a copolymer), on diene monomers (monomers bearing two conjugated or non-conjugated carbon-carbon double bonds).

The “tread” of a tire means a quantity of rubber material delimited by lateral surfaces and by two main surfaces, one of which, referred to as the tread surface, is intended to come into contact with a road surface when the tire is being driven on. When driving in a straight line and when the tire is inflated to its reference pressure, the tread surface forms a contact patch, the edges of which constitute borders between the tread and the shoulder regions. The shoulder regions therefore constitute transition regions between the tread and the sidewalls of the tire. It will be noted that the contact patch has a maximum width C defined by the E.T.R.T.O. (“European Tire and Rim Technical Organisation”) standard and in which C=(1.075-0.005ar)*S^{1.001}, where ar is the nominal aspect ratio and s is the theoretical section width on the measuring rim.

A “groove” means a cutout, the material faces of which do not touch under normal rolling conditions. Generally, the width of a groove is greater than or equal to 2 mm.

A “sipe” means a cutout that delimits two lateral walls of two adjacent blocks, said lateral walls touching under normal rolling conditions. Generally, the width of a sipe is less than 2 mm.

A radial direction means a direction which is perpendicular to the axis of rotation of the tire (this direction corresponds to the direction of the thickness of the tread).

A transverse or axial direction means a direction parallel to the axis of rotation of the tire.

A circumferential direction means a direction tangential to any circle centred on the axis of rotation of the tire. This direction is perpendicular both to the axial direction and to a radial direction.

### SUMMARY OF THE INVENTION

The invention relates to a tire comprising a tread, said tread having a tread surface designed to come into contact with the road surface, a shoulder region partially delimiting the tread, and a plurality of complex cutouts extending through the tread and through the shoulder region. Each complex cutout comprises a sipe that leads onto the tread surface and a channel that extends the sipe into the depth of the tread and leads onto a surface of the shoulder region. The channel of the sipe has a main part of width L1 that extends through the tread and a widened part that extends through the shoulder region from the main part of the channel to the surface of the shoulder region. As seen in cross section, the widened part makes, with the surface of the shoulder region, an outlet angle δ of less than 90 degrees.

The widened part of the channel ensures the transition between the main part of this channel and the shoulder region. By providing an outlet angle δ of less than 90 degrees, the outlet between the channel and the shoulder region is reinforced and the risk of the rubber tearing in the region of this outlet, during the different types of rolling of the tire, is consequently limited.

In a preferred embodiment, the outlet angle δ is between 35 degrees and 50 degrees.

This ensures good robustness of the outlet between the channel and the shoulder region but also at the border between the main part of the channel and the widened part thereof.

In another embodiment, the widened part of the channel has the overall shape of a cone.

Under wintry conditions, pieces of ice may be trapped in the widened parts of the channels, for example, when the vehicle is parked in the snow. On rolling, these pieces of ice can mechanically stress the rubber of the tread. By providing a widened channel part in the shape of a cone, the evacuation of these pieces of ice in the first few metres of rolling of the tread is encouraged.

In a preferred embodiment, the widened part of the channel is formed from a plurality of facets.

This further improves the robustness of the widened part of the channel.

In one non-limiting embodiment, the widened part has convex walls of radius R.

In this way, the jamming of stones in the channel while the tire is being driven on is limited.

In a preferred embodiment, the radius R of the convex walls decreases in the direction of the shoulder region, this variation in radius being continuous.

This makes it easier to manufacture the channel and the widening thereof during the operation of vulcanizing the tread.

In another embodiment, the widened part of the channel has a maximum width L2 at least equal to 1.5 times the width L1 of the main part of this channel.

In this way, the capacity of the channel to evacuate water from the tread while rolling on a wet road surface is improved.

### BRIEF DESCRIPTION OF THE DRAWINGS

Other features and advantages of the invention will become apparent from the following description, given by way of non-limiting example, with reference to the attached drawings in which:

FIG. 1 schematically depicts a part of a tire according to the prior art;

FIG. 2 shows a view in partial cross section of the tire from FIG. 1 in the region of a channel;

FIG. 3 schematically shows a part of a tire according to the invention in the region of an outlet of a channel;

FIG. 4 shows a view in partial cross section of the tire from FIG. 3 on the line A-A′;

FIG. 5 shows a variant embodiment of a channel of the tire from FIG. 3.

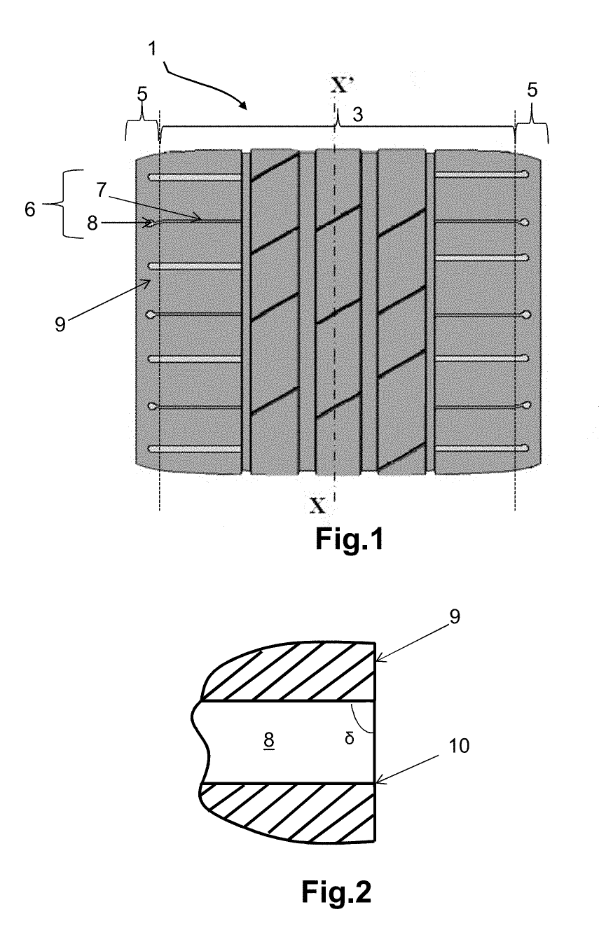

In the following description, elements which are substantially identical or similar will be denoted by identical references.

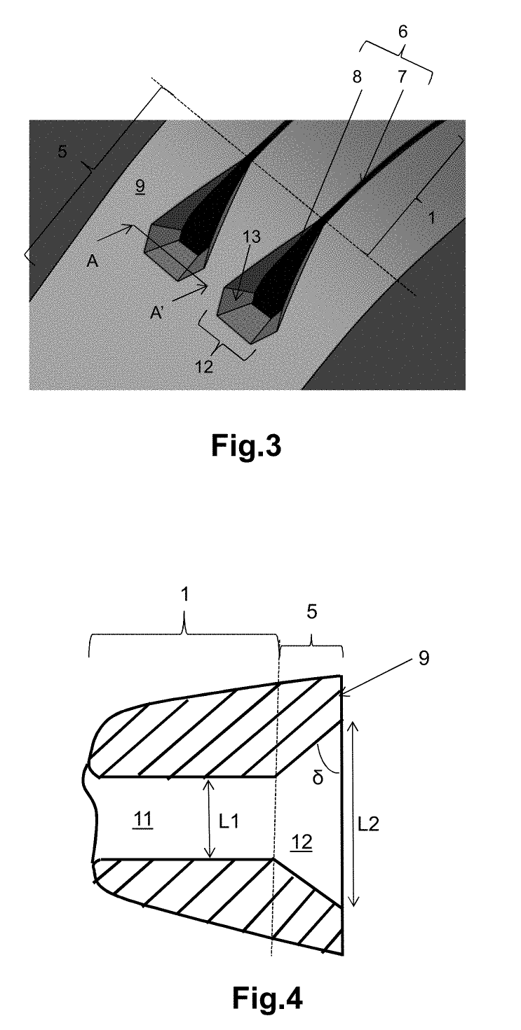

FIG. 3 shows a tire 1 in accordance with the invention. This tire comprises a tread 3 intended to come into contact with a road surface during rolling. The tread is extended by a shoulder region 5 which, under normal use conditions, does not come into contact with the road surface. The tire is provided with a plurality of complex cutouts that extend through the tread 3 and through the shoulder region 5. Each complex cutout 5 comprises a sipe 7 that leads onto the tread surface of the tread and a channel 8 that extends the sipe into the depth of the tread. The channel 8 leads onto a surface 9 of the shoulder region 5.

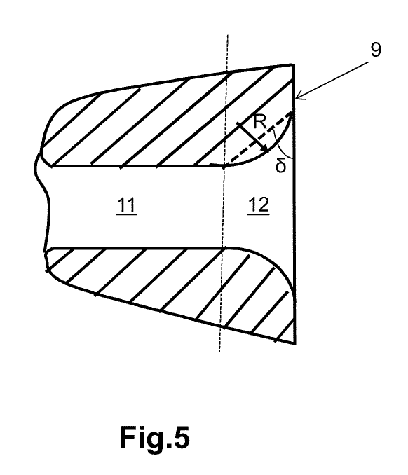

FIG. 4 shows the channel 8 in more detail. This channel 8 has a main part 11 of width L1. This main part 11 extends through the tread 3. The channel 8 also has a widened part 12. This widened part extends through the shoulder region 5 from the main part 11 of the channel to the surface 9 of the shoulder region 5. The widened part 12 makes, with this surface 9, an outlet angle δ of less than 90 degrees. In a preferred embodiment, the outlet angle δ is between 35 degrees and 50 degrees.

It will be noted that the widened part 12 in this case starts at the interface between the tread 3 and the shoulder region 5. Alternatively, it is possible for the widened part to start before this interface, that is to say in the main part 11 of the channel, or after this interface. It will also be noted that the maximum width L2 of the widened part 12 is at least equal to 1.5 times the width L1 of the main part 11 of the channel 8.

Finally, it will be noted that the widened part 12 has the overall shape of a cone. In a variant embodiment, this widened part 12 has a plurality of facets 13 that extend along the length of the widened part, as can be seen in FIG. 3.

FIG. 5 is a variant embodiment of the widened part 12. In this variant, the widened part has convex walls of radius R. In this case, this radius R is between 2 mm and 6 mm. It will be noted that the outlet angle δ is calculated in this case between the surface 9 of the shoulder region and a segment that connects a first intersection between the convex wall of the widened part and the surface 9 and a second intersection between this convex wall and the main part 11 of the channel.

In an alternative embodiment, the radius R of the convex walls varies in the direction of the shoulder region 5, for example, this radius decreases. Preferably, this variation in radius is continuous.

The invention is not limited to the examples described and shown and various modifications can be made thereto without departing from its scope.

1. A tire comprising a tread, said tread having a tread surface adapted to come into contact with the road surface, a shoulder region partially delimiting the tread, a plurality of complex cutouts extending through the tread and through the shoulder region, each said complex cutout comprising a sipe that leads onto the tread surface and a channel that extends the sipe into the depth of the tread and leads onto a surface of the shoulder region, wherein the channel of the sipe has a main part that extends through the tread and a widened part that extends through the shoulder region from the main part of the channel to the surface of the shoulder region, and wherein, as seen in cross section, the widened part makes, with the surface of the shoulder region, an outlet angle δ of less than 90 degrees.

2. The tire according to claim 1, wherein the outlet angle δ is between 35 degrees and 50 degrees.

3. The tire according to claim 1, wherein the widened part of the channel has the overall shape of a cone.

4. The tire according to claim 1, wherein the widened part has a plurality of facets.

5. The tire according to claim 1, wherein the widened part has convex walls of radius R.

6. The tire according to claim 5, wherein the radius R of the convex walls decreases in the direction of the shoulder region, this variation in radius being continuous.

7. The tire according to claim 1, wherein the widened part of the channel has a maximum width L2 at least equal to 1.5 times the width L1 of the main part of this channel.
